(19) United States
(12) Patent Application Publication
(10) Pub. No.: US 2020/0069108 A1
(43) Pub. Date: Mar. 5, 2020

(54) Liquid-Dispersing Member for a Brewing Material Holder

(71) Applicant: Adrian Rivera, Whittier, CA (US)

(72) Inventor: Adrian Rivera, Whittier, CA (US)

(21) Appl. No.: 16/543,506

(22) Filed: Aug. 16, 2019

Related U.S. Application Data
(63) Continuation-in-part of application No. 15/367,013, filed on Dec. 1, 2016, now Pat. No. 10,426,289.
(60) Provisional application No. 62/261,423, filed on Dec. 1, 2015.

(51) Int. Cl. A47J 31/46; A47J 31/44

(52) U.S. Cl. CPC A47J 31/46; A47J 31/4407

(57) ABSTRACT

A liquid-dispersion member includes inlet and dispersal chambers. The inlet chamber has a sidewall and an open end to receive a nozzle. The dispersal chamber extends from the inlet chamber and includes a distal wall having ports, and a sidewall having a distal rim attached to the distal wall and a proximal rim that can couple to a brewing material holder lid. A brewing material holder lid assembly includes a brewing material holder lid and the liquid-dispersion member. The proximal rim can be attached to the brewing material holder lid with an opening arranged in fluid communication with the open end of the inlet chamber. A brewing material holder includes a receptacle for holding brewing material, and the brewing material holder lid assembly. The brewing material holder lid can be coupled to an open end of the receptacle to extend the liquid-dispersion member within the interior of the receptacle.

### CROSS-REFERENCE TO RELATED APPLICATION

This is a continuation-in-part of co-pending U.S. patent application Ser. No. 15/367,013, which was filed on Dec. 1, 2016, which in turn is related to, and claims priority from, U.S. Provisional Application for Patent No. 62/261,423, which was filed on Dec. 1, 2015, the entire disclosure of which is incorporated herein by this reference.

### FIELD OF THE INVENTION

The present invention relates to beverage brewing and in particular to a beverage brewing device that includes rotating water dispersion into a brewing chamber, and a method of brewing a beverage using rotating water dispersion.

### BACKGROUND OF THE INVENTION

Brewed beverages are often prepared by injecting water into a brewing chamber containing a brewing material such as ground coffee beans. Conventional brewers apply variations of this type of water injection, including inserting a needle into the brewing material to inject the water, spraying streams of water down toward the brewing material, and injecting water into a dispersing member with ports in the bottom to release water into the brewing material. Unfortunately, water released or sprayed into the brewing material seeps downward through the brewing material, and any brewing material above the injection point of the streams is not exposed uniformly to the water, resulting in an unsatisfactory brewed beverage. It would be advantageous to provide a brewing system in which the liquid used to brew the beverage is applied to the brewing material in a consistent, uniform manner that extracts the maximum flavor from the material to brew a flavorful beverage.

### BRIEF SUMMARY OF THE INVENTION

The present invention addresses the above and other needs by providing a liquid-dispersion member including ports designed to provide streams of water or other liquid from above a holder containing beverage material, for uniformly dispersing the water into the brewing material. Injected water is captured in the liquid-dispersion member and directed to the ports and sprayed into the brewing material to brew the beverage. The liquid-dispersion member can be attached to a holder lid or can be part of the holder lid, or is otherwise suspended at the upper portion of the holder, above the volume that will hold the beverage material. A single, centered port can optionally also be arranged in the bottom of the liquid-dispersion member to provide an additional spray and to help drain the liquid-dispersion member after use.

According to an aspect of the invention, a liquid-dispersion member includes an inlet chamber, and a dispersal chamber. The inlet chamber has a sidewall, a distal end, and an open proximal end configured to receive and enclose an end portion of a liquid-ejection nozzle. A direction of the inlet chamber from the open proximal end toward the distal end defines a first direction. The dispersal chamber extends outward from the inlet chamber at the open proximal end. The dispersal chamber includes a distal wall generally facing the first direction. The distal wall of the dispersal chamber includes a plurality of ports configured to provide fluid communication through the distal wall.

The dispersal chamber can also include a sidewall having a distal rim attached to the distal wall and a proximal rim configured to brace against a surface. The proximal rim of the dispersal chamber sidewall can be configured to couple to an underside of a brewing material holder lid. Thus, a brewing material holder lid assembly can include a brewing material holder lid having an opening, and the liquid-dispersion member. The proximal rim of the dispersal chamber sidewall can be attached to the underside of the brewing material holder lid such that the brewing material holder lid opening is arranged in fluid communication with the open proximal end of the inlet chamber. A brewing material holder can include a receptacle and the brewing material holder lid assembly of the invention. The receptacle has an interior configured to hold brewing material. The brewing material holder lid is configured to be removably coupled to an open end of the receptacle such that the liquid-dispersion member extends within the interior of the receptacle.

The dispersal chamber can also include a proximal wall attached to the proximal rim of the dispersal chamber sidewall. The proximal wall of the dispersal chamber can be configured to couple to an underside of a brewing material holder lid. Thus, a brewing material holder lid assembly can include a brewing material holder lid having an opening, and the liquid-dispersion member. The proximal wall of the dispersal chamber can be attached to the underside of the brewing material holder lid such that the brewing material holder lid opening is arranged in fluid communication with the open proximal end of the inlet chamber. A brewing material holder can include a receptacle having an interior configured to hold brewing material, and the brewing material holder lid assembly, which can be configured to be removably coupled to an open end of the receptacle such that the liquid-dispersion member extends within the interior of the receptacle. The dispersal chamber sidewall can be sealed to the distal wall over the entire distal rim, and sealed to the proximal wall over the entire proximal rim.

The distal end of the inlet chamber can be closed.

The distal end of the inlet chamber can be rounded.

The distal end of the inlet chamber can have at least one port configured to provide fluid communication therethrough.

The inlet chamber can be elongated.

The plurality of ports of the distal wall of the dispersal chamber can be arranged in a pattern. For example, the pattern can be circular, such as a single circle or multiple concentric circles.

According to another aspect of the invention, a liquid-dispersion member includes inlet means for receiving and enclosing an end portion of a liquid-ejection nozzle, including an open proximal end and a distal end, and fluid dispersal means for dispersion fluid received in the inlet means, extending outward from the inlet means at the open proximal end. A direction from the open proximal end toward the distal end defines a first direction. The fluid dispersal means includes a distal wall generally facing the first direction. The distal wall of the fluid dispersal means includes a plurality of ports configured to provide fluid communication through the distal wall.

### BRIEF DESCRIPTION OF THE DRAWINGS

These and other aspects, features, and advantages of the present invention are more fully disclosed in the following more detailed description thereof, with reference to the following drawings wherein:

FIG. 1A is a front view of an exemplary beverage brewer.

FIG. 1B is a side view of the exemplary beverage brewer of FIG. 1A.

FIG. 1C is a top view of the exemplary beverage brewer of FIG. 1A.

FIG. 2 is a side view of the exemplary beverage brewer of FIG. 1A with an open lid.

FIG. 2A is a functional diagram of the exemplary beverage brewer of FIG. 1A.

FIG. 3A is a top view of an exemplary brewing material holder according to the present invention.

FIG. 3B is a side view of the exemplary brewing material holder of FIG. 3A.

FIG. 4 is a cross-sectional view of the exemplary brewing material holder of FIG. 3A taken along line 4-4.

FIG. 5A is a top view of an exemplary brewing material holder lid according to the present invention.

FIG. 5B is a side view of the exemplary brewing material holder lid of FIG. 5A.

FIG. 5C is a bottom view of the exemplary brewing material holder lid of FIG. 5A.

FIG. 6 is a cross-sectional view of the exemplary brewing material holder lid of FIG. 5A taken along line 6-6.

FIG. 7 is a cross-sectional view of another exemplary brewing material holder according to the present invention taken along line 4-4 of FIG. 3A.

FIG. 8 is a bottom view of an exemplary liquid-dispersion member corresponding to the exemplary brewing material holder of FIG. 7.

FIG. 9 is a cross-sectional view of another exemplary brewing material holder according to the present invention taken along line 4-4 of FIG. 3A.

FIG. 10 is a bottom view of an exemplary liquid-dispersion member corresponding to the exemplary brewing material holder of FIG. 9.

FIG. 11 is a cross-sectional view of another exemplary brewing material holder according to the present invention taken along line 4-4 of FIG. 3A.

FIG. 12 is a bottom view of an exemplary liquid-dispersion member corresponding to the exemplary brewing material holder of FIG. 11.

FIG. 13 shows an exploded view of an exemplary holder with mesh material in walls of the receptacle.

FIG. 14 shows an exploded view of an exemplary holder with a filter paper cup inserted into the receptacle.

Corresponding reference characters indicate corresponding elements throughout the several views of the drawings.

### DETAILED DESCRIPTION OF THE INVENTION

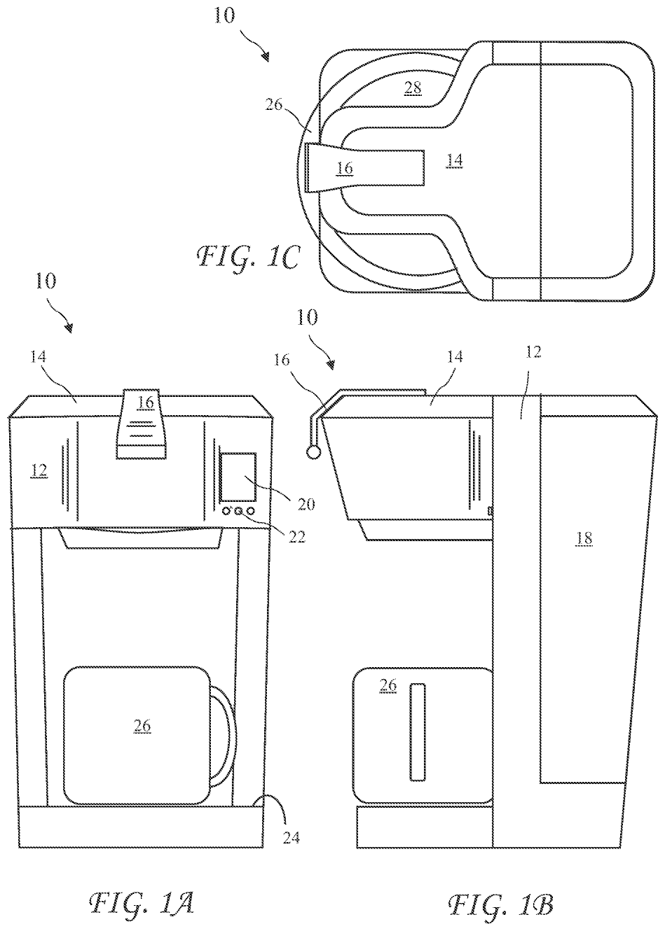

As shown in FIGS. 1A-1C, an exemplary beverage brewer 10, such as a coffee maker, includes a base 12, an opening lid 14, a lid handle 16, a water container 18, a display 20, controls 22, and platform 24 on which a cup 26 can rest. The beverage brewer 10 provides a flow of hot water through brewing material to produce a brewed drink. The flow of water can be heated by one of any known means, for example, an electrical heating coil, inductive heating, or a conductive coating on tubing carrying the water.

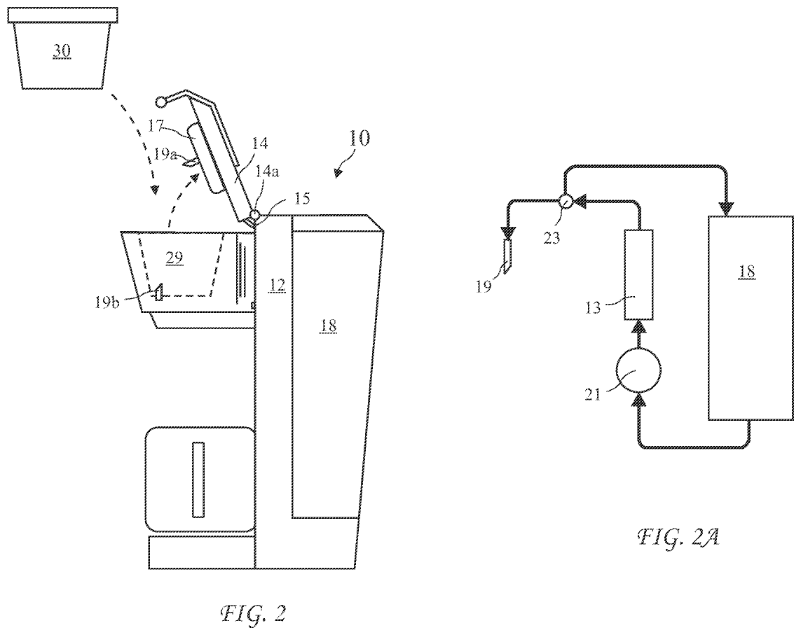

As shown in FIG. 2, the lid 14 of the beverage brewer 10 can be opened to allow placement of a brewing material holder 30 inside a brewing chamber 29 of the beverage brewer 10. The lid 14 includes a lid hinge 14a, and a water tube 15 can be used to allow heated water to flow under the lid 14. A pad 17 disposed on a bottom surface of the lid 14 presses against the brewing material holder 30 when the lid 14 is closed, and in cooperation with other means, holds the brewing material holder 30 in place and can be used to tamp ground beverage material contained in the brewing material holder 30. A nozzle (or injection needle) 19a extending down from the closed lid 14 directs the flow of hot water into the brewing material holder 30, or the water is otherwise directed into the brewing material holder 30. A bottom puncture needle 19b extends up into the brewing chamber 29 to puncture single-use brewing cartridges or the like. In other conventional beverage brewers, the bottom puncture needle 19b might not be present, and the brewed beverage passes through to the cup 26 below through an opening or other conduit.

A functional diagram of the beverage brewer 10 is shown in FIG. 2A. The exemplary beverage brewer 10 includes the water tank 18, water pump 21, a heater 13, check valve 23 and the nozzle 18. The water heater 13 can include a heating coil, inductive heating, or a resistive coating or any other means for heating water. The check valve 23 limits the water pressure at the nozzle 19a by returning some of the water flow to the water tank 18. While the water pump 21 is shown as providing a flow of water to the nozzle 19a, any means of providing a flow of water can be used.

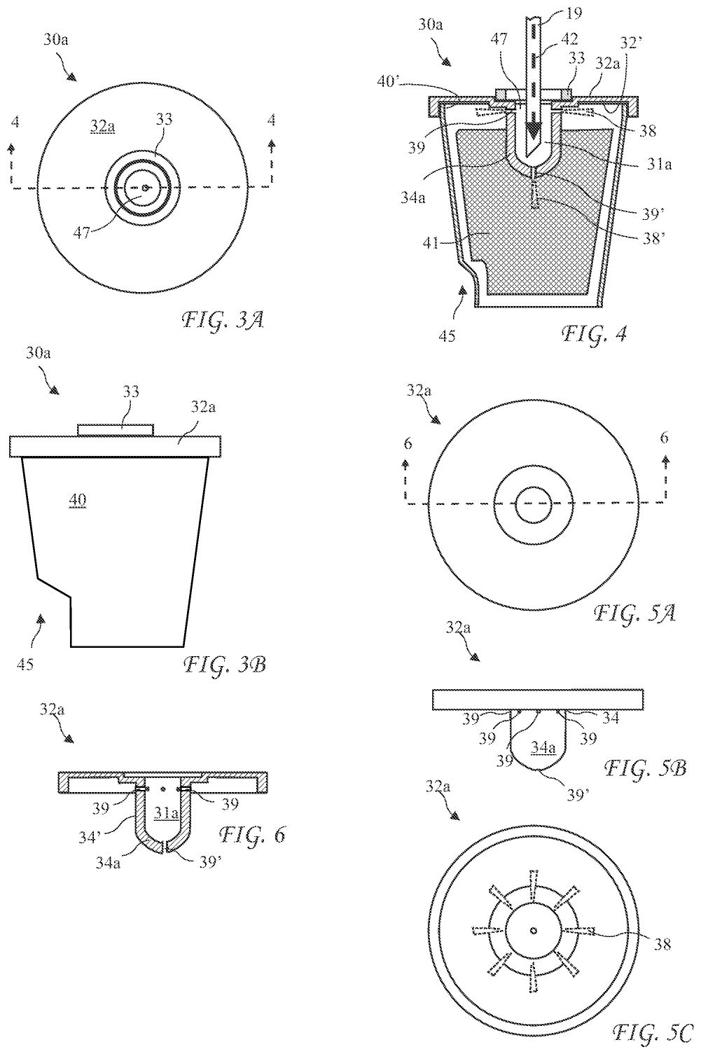

With reference to FIGS. 3A and B, the brewing material holder 30a includes a receptacle 40 and a removable lid 32a. The receptacle 40 has an interior configured to hold brewing material. The brewing material holder lid 32a is configured to be removably coupled to an open end of the receptacle, in order to cover the receptacle 40 when it contains brewing material. A seal 33 can be included, disposed on the lid 32a, to seal to the beverage brewer 10 (see FIG. 2). A flow of water 42 is provided, preferably under pressure, through the nozzle (or injection needle) 19a into the brewing material holder 30a. Thus, the brewing material holder 30a is of the type that can be used in many conventional beverage brewers. For example, the holder 30a can be configured to allow use in coffee makers sold under the trademark KEURIG®, which include a top puncture injection needle 19a for puncturing and injecting pressurized water into a pre-packaged, single-use, brewing cartridge, and a bottom puncture needle for puncturing the pre-packaged, single-use, brewing cartridge to extract brewed beverage. Such coffee makers are described, for example, in U.S. Pat. No. 5,325,765. The brewing material holder 30a can be used in such a brewer, in place of the pre-packaged, single-use, brewing cartridge.

The flow of water 42 enters the brewing material holder 30a through a passage 47 in the lid 32a. The passage 47 is preferably configured to accept the top puncture needle or nozzle of the beverage brewer. The receptacle 40 may further include a bottom recess 45 to avoid the bottom needle if the brewer is the type that has one. The recess 45 may be arranged into the side of the holder, or into the bottom of the holder receptacle 40. In other embodiments, the holder receptacle 40 can be configured such that an injection needle or an extraction needle can penetrate or be accommodated by the receptacle 40 from a side rather than the top or bottom.

Referring to FIG. 4, the liquid-dispersion member 34a is coupled or fixed to the lid 32a or an integral element of the lid 32a, capturing the flow of liquid 42 from the injection needle or nozzle 19 in an inlet chamber 31a As the inlet chamber 31a fills, the water level rises and reaches ports 39 just under a bottom surface 32′ of the lid 32a, producing radial, generally horizontal sprays of water 38 toward an outer top edge 40′ of the receptacle 40. The inlet chamber 31a can have a generally elongated shape but can have any shape such that it can receive and enclose the injection needle or nozzle 19 or otherwise accept the flow of liquid. The tip of the inlet chamber 31a can be blunt or rounded, and can be closed off or can include a port 39′, or several ports, to allow central flow of liquid from the liquid-dispersion member 34a.

Referring to FIGS. 5A-C and 6, an exemplary liquid-dispersion member 34a includes the inlet chamber 31a and any number of, in this case eight, evenly angularly spaced apart, radially-aligned ports 39, providing eight evenly angularly spaced apart, radially-directed sprays 38. Within the scope of this embodiment, the liquid-dispersion member 34a can include between any number of ports, spaced at any regular or irregular intervals, and at the same or different positions along the length of the liquid-dispersion member 34a. The inlet chamber 31a can have a generally elongated shape but can have any shape such that it can receive and enclose the injection needle or nozzle 19 or otherwise accept the flow of liquid. The tip of the inlet chamber 31a can be blunt or rounded, and can be closed off or can include a port 39′, or several ports, to allow central flow of liquid from the liquid-dispersion member 34a.

Referring to FIGS. 7 and 8, a liquid-dispersion member 34b includes an inlet chamber as in the previous embodiments, and a dispersal chamber 31b arranged in fluid communication with the inlet chamber. As shown, the inlet chamber has a sidewall, a distal end or tip, and an open proximal end configured to receive and enclose an end portion of a liquid-ejection nozzle or needle 19. Thus, the nozzle 19 is inserted into the inlet chamber in a first direction, from the open proximal end toward the distal end. The dispersal chamber 31b extends outward from the inlet chamber at the open proximal end, and in the embodiment shown has a circular cross-section, although any shape is contemplated for use within the scope of the invention. The dispersal chamber 31b includes a distal wall 31′ generally facing the first direction, that is, downward toward the distal end of the inlet chamber in the orientation shown. The distal wall 31′ of the dispersal chamber 31b includes a number of ports 39 configured to provide fluid communication through the distal wall 31′. The ports 39 are aimed generally downward from the distal wall 31′ of the dispersal chamber 31b. The ports 39 can be arranged in any manner, such as generally radially centered between an outer edge 34′ of the second water dispersion member 34b and the outer top edge of the receptacle 40′ as shown, Any number of ports 39 can be arranged in the distal wall 31′, arranged in a circular pattern as shown or distributed in any other manner. The inlet chamber can have a generally elongated shape but can have any shape such that it can receive and enclose the injection needle or nozzle 19 or otherwise accept the flow of liquid. The tip of the inlet chamber can be blunt or rounded, and can be closed off or can include a port 39′, or several ports, to allow central flow of liquid 38′ from the liquid-dispersion member 34a.

The liquid-dispersion member 34b can be a separate element that is arranged in cooperation with the brewing material holder lid or can be fixed to or formed integrally with brewing material holder lid. For example, the dispersal chamber 31b can also include a proximal wall attached to the proximal rim of the dispersal chamber 31b sidewall. The proximal wall of the dispersal chamber 31b can be configured to couple to an underside of a brewing material holder lid. The proximal wall of the dispersal chamber 31b can be coupled or attached to the underside of the brewing material holder lid such that the brewing material holder lid opening is arranged in fluid communication with the open proximal end of the inlet chamber. Thus, a brewing material holder lid assembly can include a brewing material holder lid having an opening, and the liquid-dispersion member. Likewise, a brewing material holder can include a receptacle having an interior configured to hold brewing material, and the brewing material holder lid assembly, which can be configured to be removably coupled to an open end of the base such that the liquid-dispersion member 34b extends within the interior of the receptacle. If desired, the dispersal chamber 31b sidewall can be sealed to the distal wall over the entire distal rim, and sealed to the proximal wall over the entire proximal rim.

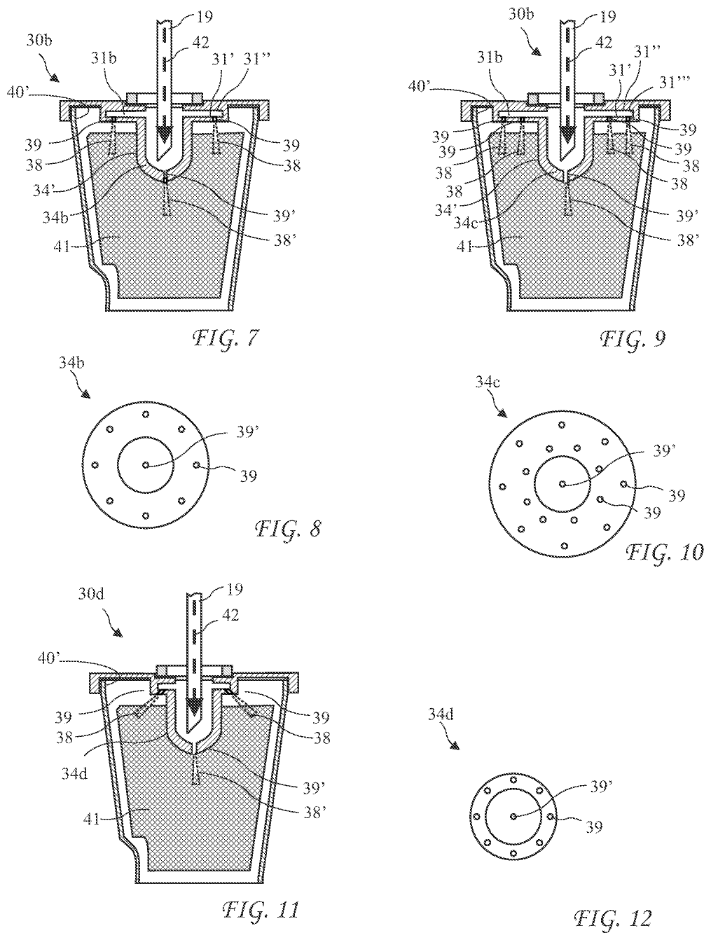

With reference to FIGS. 9 and 10, an exemplary liquid-dispersion member 34c includes inner and outer circles of ports 39 aimed downward from the distal wall 31′ of the dispersal chamber 31b, and can include a centered port 39′ in the end of the inlet chamber. For example, the two circles of ports 39 can be radially spaced about ⅓ and ⅔ of the distance between the outer edge 34′ of the liquid-dispersion member 34c and the outer top rim of the receptacle 40′. Although 16 ports 39 are shown, any number of ports can be arranged in the distal wall 31′ of the liquid-dispersion member 34c, in any number of circles, or in any other pattern. The ports 39 can be configured, such as by arrangement of the angle of each port through the distal wall 31′, to direct the liquid as desired as it passed through the port 39. For example, referring to FIGS. 11 and 12, an exemplary liquid-dispersion member 34d includes a circle of ports 39 aimed downward and outward from a distal wall 31′ of the dispersal chamber 31b. The ports 39 can be configured to direct the flow of liquid at any angle or combination of angles with respect to the plurality of ports 39.

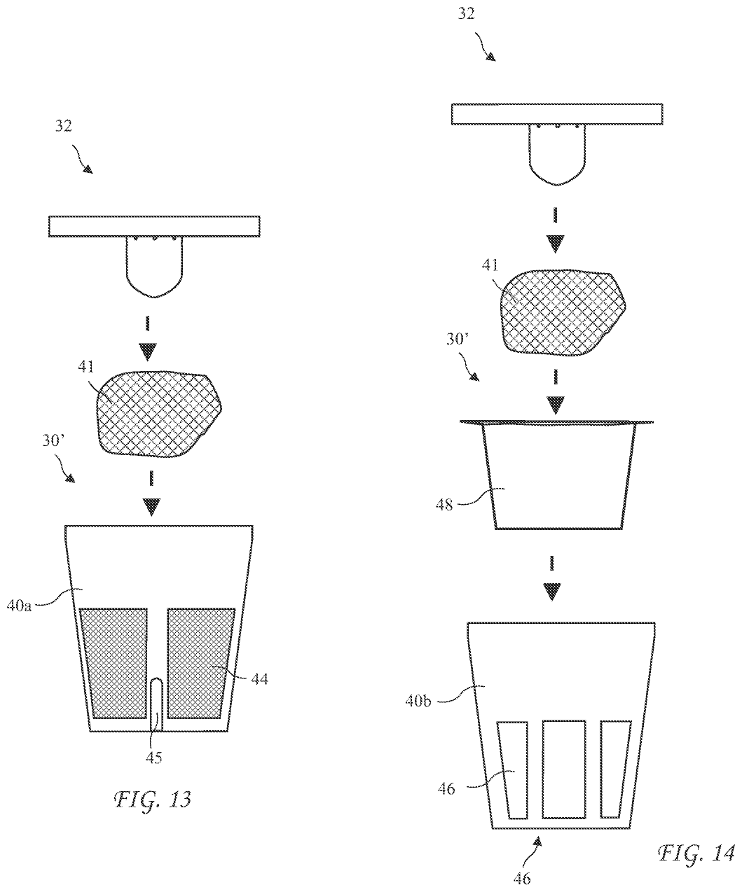

Referring to FIGS. 13 and 14, openings 46 are provided in the walls and/or bottom of the receptacle 40b to allow the brewed beverage to flow from the receptacle 40b and into the drinking cup or serving carafe or the like. The lids and water dispersion members described above can be used with either holder receptacle 40a and 40b or any other receptacle that can contain beverage brewing material and allow a brewed beverage to flow from the receptacle. As shown, the openings 46 in the receptacle 40a can be covered with a mesh material 44, or the beverage brewing material can be encapsulated in a mesh material or porous paper 48 prior to being placed in the receptacle 40b. The receptacle can include a mesh-covered bottom opening instead, or any type of fluid passageway.

The present invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The scope of the appended claims, therefore, should be accorded the broadest reasonable interpretation so as to encompass all such modifications and similar arrangements.

I claim:

1. A liquid-dispersion member, comprising:
an inlet chamber having a sidewall, a distal end, and an open proximal end, configured to receive and enclose an end portion of a liquid-ejection nozzle, wherein a direction of the inlet chamber from the open proximal end toward the distal end defines a first direction; and
a dispersal chamber extending outward from the inlet chamber at the open proximal end, wherein the dispersal chamber includes a distal wall generally facing the first direction;
wherein the distal wall of the dispersal chamber includes a plurality of ports configured to provide fluid communication through the distal wall.

2. The liquid-dispersion member of claim 1, wherein the dispersal chamber further includes a sidewall having a distal rim attached to the distal wall and a proximal rim configured to brace against a surface.

3. The liquid-dispersion member of claim 2, wherein the proximal rim of the dispersal chamber sidewall is configured to couple to an underside of a brewing material holder lid.

4. A brewing material holder lid assembly, comprising:
a brewing material holder lid having an opening; and
the liquid-dispersion member of claim 3, wherein the proximal rim of the dispersal chamber sidewall is attached to the underside of the brewing material holder lid such that the brewing material holder lid opening is arranged in fluid communication with the open proximal end of the inlet chamber.

5. A brewing material holder, comprising:
a receptacle having an interior configured to hold brewing material; and
the brewing material holder lid assembly of claim 4, configured to be removably coupled to an open end of the receptacle such that the liquid-dispersion member extends within the interior of the receptacle.

6. The liquid-dispersion member of claim 2, wherein the dispersal chamber further includes a proximal wall attached to the proximal rim of the dispersal chamber sidewall.

7. The liquid-dispersion member of claim 6, wherein the proximal wall of the dispersal chamber is configured to couple to an underside of a brewing material holder lid.

8. A brewing material holder lid assembly, comprising:
a brewing material holder lid having an opening; and
the liquid-dispersion member of claim 7, wherein the proximal wall of the dispersal chamber is attached to the underside of the brewing material holder lid such that the brewing material holder lid opening is arranged in fluid communication with the open proximal end of the inlet chamber.

9. A brewing material holder, comprising:
a receptacle having an interior configured to hold brewing material; and
the brewing material holder lid assembly of claim 8, configured to be removably coupled to an open end of the receptacle such that the liquid-dispersion member extends within the interior of the receptacle.

10. The liquid-dispersion member of claim 6, wherein the dispersal chamber sidewall is:
sealed to the distal wall over the entire distal rim, and
sealed to the proximal wall over the entire proximal rim.

11. The liquid-dispersion member of claim 1, wherein the distal end of the inlet chamber is closed.

12. The liquid-dispersion member of claim 1, wherein the distal end of the inlet chamber is rounded.

13. The liquid-dispersion member of claim 1, wherein the distal end of the inlet chamber has at least one port configured to provide fluid communication therethrough.

14. The liquid-dispersion member of claim 1, wherein the inlet chamber is elongated.

15. The liquid-dispersion member of claim 1, wherein the plurality of ports of the distal wall of the dispersal chamber are arranged in a pattern.

16. The liquid-dispersion member of claim 15, wherein the pattern is circular.

17. The liquid-dispersion member of claim 16, wherein the pattern is a single circle.

18. The liquid-dispersion member of claim 16, wherein the pattern is multiple concentric circles.

19. A liquid-dispersion member, comprising:
inlet means for receiving and enclosing an end portion of a liquid-ejection nozzle, including an open proximal end and a distal end, wherein a direction from the open proximal end toward the distal end defines a first direction; and
fluid dispersal means for dispersion fluid received in the inlet means, extending outward from the inlet means at the open proximal end, wherein the fluid dispersal means includes a distal wall generally facing the first direction;
wherein the distal wall of the fluid dispersal means includes a plurality of ports configured to provide fluid communication through the distal wall.
